(19) United States
(12) Patent Application Publication
(10) Pub. No.: US 2018/0326271 A1
(43) Pub. Date: Nov. 15, 2018

(54) BALL THROWING DEVICE

(71) Applicant: Philip Vincent Cartledge, Vale of Glamorgan (GB)

(72) Inventor: Philip Vincent Cartledge, Vale of Glamorgan (GB)

(73) Assignee: HANDIPOD LIMITED, South Glamorgan (GB)

(21) Appl. No.: 16/045,397

(22) Filed: Jul. 25, 2018

Related U.S. Application Data
(63) Continuation-in-part of application No. PCT/GB2017/050216, filed on Jan. 27, 2017.

(30) Foreign Application Priority Data
Jan. 29, 2016 (GB) 1601661.0

(51) Int. Cl. A63B 59/20; E01H 1/12; A63B 60/16

(52) U.S. Cl. CPC A63B 59/20; E01H 1/1206; A63B 60/12; A63B 2208/14; A63B 2225/687; A63B 60/16

(57) ABSTRACT

A ball throwing device for dog owners includes a handle connected to a head with an elongate shaft, the head defining an opening into which a ball can be inserted. The handle further includes a hollow interior to receive a roll of pet waste bags, an aperture being provided in the side wall of the handle, through which the bags can be dispensed.

### CROSS-REFERENCE TO PRIOR APPLICATION

This is a continuation-in-part of P.C.T. Application No. PCT/GB2017/050216, filed Jan. 27, 2017, and which designates the United States of America.

### BACKGROUND OF THE INVENTION

### Technical Field of the Invention

This invention relates to a ball throwing device of the kind used by dog owners.

### Description of the Prior Art

Many dog owners throw balls for their dog to retrieve and return. This provides good exercise for the dog and increases the bond between the dog and its owner. The distance over which a ball can be thrown is limited and this has the disadvantage that the owner has to repeatedly throw the ball, which can be tiresome and both the dog and its owner can lose interest in the activity.

In order to overcome the above-mentioned problem, ball throwing devices of the kind disclosed in U.S. Pat. No. 6,076,829 have become popular with dog owners. Such ball throwing devices comprise a handle connected to a head by an elongate shaft. The head defines an opening into which a tennis ball for example can be inserted, such that the ball is resiliently held in-situ. In use a dog owner grasps the handle and swings the device, causing the ball to be ejected from the head at speed when the swinging motion decelerates or stops. The speed at which the ball is thrown is far greater than can be achieved by hand and thus the dog has to travel further to retrieve and return the ball.

Nowadays most dog owners carry a supply of pet waste bags that can be used to pick up and hold dog faeces that is deposited whilst walking their dog. However, some-times a dog owner may forget to take bags or may not take enough, for example if they have several dogs.

The inventor has now devised a ball throwing device which alleviates the above-mentioned problem.

### SUMMARY OF THE INVENTION

In accordance with the present invention, there is provided a ball throwing device comprising a tubular handle connected to a head via an elongate shaft, the head defining an opening into which a ball can be inserted, wherein the handle comprises a hollow interior adapted to receive a roll of pet waste bags, an aperture being provided in the side wall of the handle, through which the bags can be dispensed.

It has been recognized realised that people who use ball throwing devices will habitually carry them on dog walks and, since the ball throwing device of the present invention holds a supply of pet waste bags, the risk of not having a bag or a sufficient supply of bags is avoided. The present invention also reduces the number of articles that dog owners have to remember and carry when going out on dog walks.

The handle may comprise an opening through which the roll of bags can be inserted into its hollow interior.

A closure may be provided for closing the opening.

The opening may be provided at a proximal end of the handle, the shaft extending from the distal end of the handle.

In one embodiment, the closure comprises a cap which can be engaged with the handle.

In another embodiment, the closure comprises a container which can be engaged with the handle, the container holding a supply of a sanitizing liquid or gel that the user can use to sanitize their hands after picking up dog waste with one of the bags that has been dispensed from the handle.

The container may be tubular and may be of a cross-sectional shape which corresponds to the cross-sectional shape of the handle.

The container may comprise an outlet for the liquid or gel and a closure for closing the outlet.

The container may comprise a reservoir portion which contains the liquid or gel and a lid portion, the outlet and the closure being provided by the lid portion. The lid portion may be removable from the reservoir portion to allow the reservoir portion to be filled through a dispensing orifice thereof.

The aperture in the handle may face in substantially the same direction as the opening in the head.

The aperture may be provided at one end of the handle, so that the handle can be grasped at a point away from the aperture.

Also in accordance with the present invention there is provided a ball throwing device as hereinbefore described comprising a roll of pet waste bags disposed inside the tubular handle.

Preferably the axis of the roll extends axially of the handle.

Other objects and features of the present invention will become apparent when considered in combination with the accompanying drawing figures, which illustrate a certain preferred embodiments of the present invention. It should, however, be noted that the accompanying drawing figures are intended to illustrate only select preferred embodiments of the claimed invention and are not intended as a means for defining the limits and scope of the invention.

### BRIEF DESCRIPTION OF THE DRAWING FIGURES

In the drawing figures, wherein similar features are denoted with similar reference numerals throughout the several views:

FIG. 1 is a left side view of an embodiment of ball throwing device in accordance with the present invention;

FIG. 2 is a rear view of the ball throwing device of FIG. 1;

FIG. 3 is a left side view of a second embodiment of ball throwing device in accordance with the present invention; and,

FIG. 4 is a left side view of a third embodiment of ball throwing device in accordance with the present invention.

### DETAILED DESCRIPTION OF THE DRAWING FIGURES AND PREFERRED EMBODIMENTS

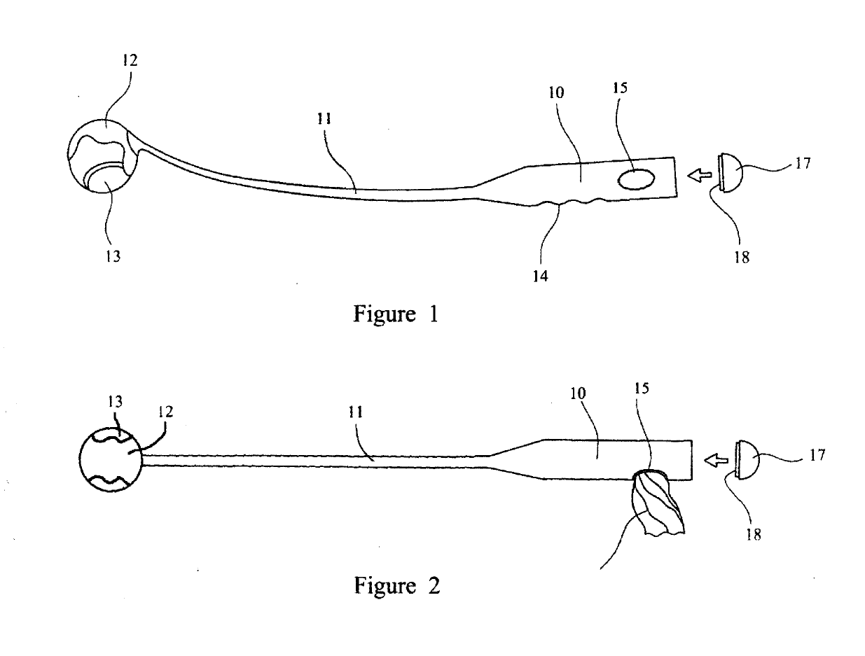

Referring to FIGS. 1 and 2 of the drawings, there is shown a ball throwing device comprising a hollow tubular handle 10 connected to a head 12 via an elongate shaft 11 which extends axially from the distal end of the handle 10. The head 12 defines a forwardly-facing opening or socket into which a ball 13 can be inserted. The head 12 is arranged to resiliently engage the ball 13.

The proximal end of the hollow tubular handle 10 is open to allow a roll (not shown) of pet waste bags to be inserted into the interior of the handle 10. An aperture 15 is formed in the left side of the tubular handle 10 adjacent one end to allow the outermost pet waste bag 16 of the roll to be pulled radially out of the handle 10. The device is normally hung in retail outlets by a display card fitted to the head 12, such that the opening or socket in the head faces to the left. Hence, the reason that the aperture 15 is formed in the left side of the handle 10 is so that purchasers can readily see that the device is adapted to dispense pet waste bags.

A cap 17 is provided for fitting to the proximal end of the handle 10, the cap 17 comprising a ribbed flange 18 which extends into the tubular handle 10 to retain the cap 17 in-situ. A plurality of ribs 14 are provided on the front of the handle 10 to provide recesses into which a user's fingers can be placed when holding the device.

In use, the device can be used to throw the ball 13 over a great distance in the manner as hereinbefore described. In the event that the user's dog defecates, the user is able to pull the protruding pet waste bag 16 out of the handle 10 sufficiently for it to be torn from the next pet waste bag in the roll. The bag can then be used to pick up the faeces.

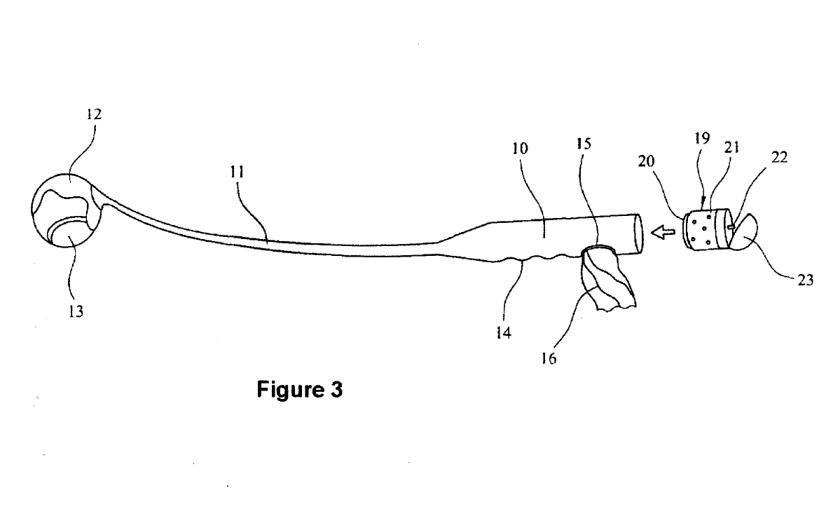

Referring to FIG. 3 of the drawings, there is shown an alternative embodiment of ball throwing device in accordance with the present invention, which is similar in construction to the ball throwing device of FIG. 1 and like parts are given like reference numerals. In this embodiment, the cap 17 is replaced by a container 19 that contains a sanitizing liquid or gel in a tubular reservoir portion 21 thereof. The diameter of the reservoir portion 21 is the same as the diameter of the proximal end of the handle 10. The distal end of the container 19 comprises a ribbed flange 20 which can be detachably inserted into the open proximal end of the tubular handle 10. The proximal end of the reservoir portion 21 is fitted to a detachable lid portion 22, which comprises an outlet through which the liquid or gel can be dispensed when the side wall of the reservoir portion 21 is squeezed. A cap 23 is pivotally mounted to the lid portion 21 for closing the outlet. In this embodiment, aperture 15 is provided in the front of the handle 10.

In use, once faeces has been picked up with a bag, the user is able to sanitize their hands by opening the cap 23 and squeezing the reservoir portion 21 to dispense the sanitising liquid or gel onto their hands.

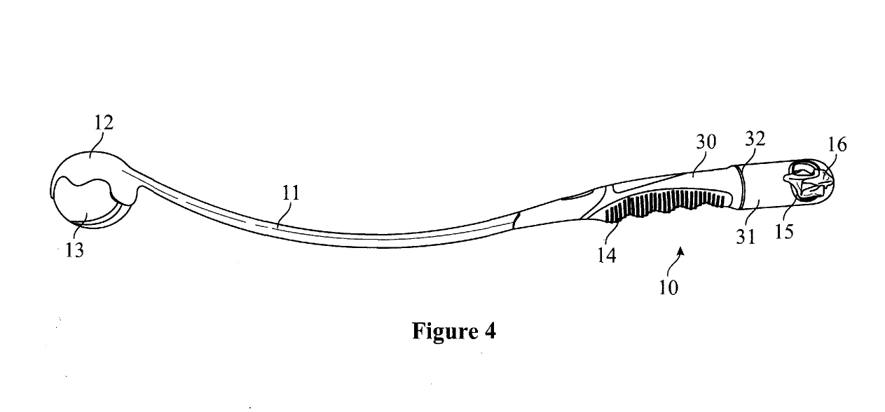

Referring to FIG. 4 of the drawings, there is shown a further embodiment of ball throwing device in accordance with the present invention, which is similar in construction to the ball throwing device of FIG. 1 and like parts are given like reference numerals. In this embodiment, the handle 10 comprises a body portion 30 and a detachable end portion 31. The body portion 30 of the handle 10 is formed as one-piece moulding of plastics material with the head 12 and elongate shaft 11. The body portion 30 of the handle 10 may be hollow or solid and the front thereof is provided with a plurality of ribs 14, which provide recesses into which a user's fingers can be placed when holding the device.

The detachable end portion 31 of the handle 10 comprises a tubular wall side which is open at its distal end and is closed at its proximal end by a dome-shaped end wall. The open distal end of the end portion 31 of the handle 10 is adapted to securely and detachably engage the proximal end of the body portion 30 of the handle 10. When detached, the open distal end of the end portion 31 of the handle 10 allows a roll of pet waste bags to be inserted into the interior thereof. An aperture 15 is formed in the tubular side wall of the end portion 31 of the handle 10 adjacent its proximal end, so as to allow the outermost pet waste bag 16 of the roll to be pulled radially out of the handle 10.

The device is normally hung in retail outlets by a display card fitted to the head 12, such that the opening or socket in the head 12 faces to the left. Hence, the rotational position of the detachable end portion 31 of the handle 10 relative to the body portion 30 is controlled so that purchasers can readily see the aperture 15 and that the device is adapted to dispense pet waste bags. In that regard, the tubular side wall of the detachable end portion 31 of the handle 10 comprises an internal screw thread which engages an external screw thread on the proximal end of the body portion 30 of the handle 10. When the detachable end portion 31 of the handle 10 is threadably engaged with the body portion 30 of the handle 10, further rotation of the end portion 31 is prevented once the aperture 15 therein faces perpendicular to the head 12 in the direction shown in FIG. 4. The opening 15 is provided at the proximal end of the handle 10, so that the handle 10 can be grasped at a point away from the opening 15.

A ball throwing device in accordance with the present invention is simple and inexpensive in construction, yet allows dog owners to always have a supply of pet waste bags to hand when out walking their dog with the device.

While only several embodiments of the present invention have been shown and described, it will be obvious to those skilled in the art that many modifications may be made to the present invention without departing from the spirit and scope thereof.

What is claimed is:

1. A ball throwing device comprising a tubular handle connected to a head via an elongate shaft, the head defining an opening into which a ball is able to be inserted, wherein the tubular handle comprises a hollow interior for receiving a roll of pet waste bags and a side wall of the tubular handle has an aperture through which the bags are able to be dispensed.

2. The ball throwing device as claimed in claim 1, wherein the tubular handle includes an opening through which the roll of bags is able to be inserted into its hollow interior.

3. The ball throwing device as claimed in claim 2, wherein the opening is provided at a proximal end of the tubular handle, the shaft extending from the distal end of the tubular handle.

4. The ball throwing device as claimed in claim 2, further comprising a closure for closing the opening.

5. The ball throwing device as claimed in claim 4, wherein the closure comprises a cap engageable with the tubular handle.

6. The ball throwing device as claimed in claim 4, wherein the closure comprises a container engageable with the tubular handle, the container holding a supply of a sanitizing liquid or gel.

7. The ball throwing device as claimed in claim 6, wherein the container is tubular and of a cross-sectional shape and corresponds to the cross-sectional shape of the tubular handle.

8. The ball throwing device as claimed in claim 1, wherein the aperture in the tubular handle faces substantially perpendicular to the opening in the head.

9. The ball throwing device as claimed in any claim 1, further comprising a roll of pet waste bags disposed inside the tubular handle.

10. The ball throwing device as claimed in claim 1, wherein an axis of the roll extends axially of the tubular handle.

11. A ball throwing device comprising a handle connected to a head via an elongate shaft, the head defining an opening into which a ball is able to be inserted, wherein the handle comprises a body portion and a detachable end portion, the end portion being adapted to receive a roll of pet waste bags and a side wall of the end portion having an aperture therein through which the bags are able to be dispensed.

12. The ball throwing device as claimed in claim 11, wherein the end portion is tubular and comprises an opening at its distal end, through which the roll of bags is able to be inserted into a hollow interior thereof.

13. The ball throwing device as claimed in claim 11, wherein the distal end of the end portion of the handle is adapted to snap-engage with the proximal end of the body portion of the handle.

14. The ball throwing device as claimed in claim 11, wherein the distal end of the end portion of the handle is adapted to threadably-engage with the proximal end of the body portion of the handle.

15. The ball throwing device as claimed in claim 11, wherein the distal end of the end portion of the handle is adapted to twist-engage with the proximal end of the body portion of the handle.

16. The ball throwing device as claimed in claim 11, wherein the aperture in the end portion of the handle faces substantially perpendicular to the opening in the head when the end portion of the handle is fitted to the body portion of the handle.

17. The ball throwing device as claimed in claim 11, further comprising a roll of pet waste bags disposed inside the tubular handle.

18. The ball throwing device as claimed in claim 17, wherein an axis of the roll extends axially of the handle.
